(19) United States
(12) Patent Application Publication
(10) Pub. No.: US 2005/0077118 A1
(43) Pub. Date: Apr. 14, 2005

(54) Hydraulic operating device for a parking brake

(75) Inventors: Georg Kubina, Hamburg (DE); Eckhard Reese, Apensen (DE); Thomas Roepke, Stelle (DE); Kai Sascha Zimmermann, Drage (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/922,157

(22) Filed: Aug. 20, 2004

(30) Foreign Application Priority Data
Aug. 23, 2003 (DE) 103 38 763.3

(51) Int. Cl. F16C 1/16

(52) U.S. Cl. 188/2 D

(57) ABSTRACT

The invention concerns a hydraulic actuating system for a parking brake of a motor vehicle, with which the parking brake is hydraulically set by means of a setting mechanism through the use of the pressure stored in a pressure accumulator and is mechanically locked in the braking position by a triggering device.

This application claims the priority of German Patent Document No. 103 38 763.3, filed Aug. 23, 2003, the disclosure of which is expressly incorporated by reference herein.

### BACKGROUND AND SUMMARY OF THE INVENTION

The invention relates to a hydraulic device for operating a parking brake, having a locking device which is coupled with the parking brake and by which the parking brake can be mechanically set.

It is known to operate a parking brake of a vehicle hydraulically and to hold the parking brake mechanically in the braking position. Consequently, when the vehicle is not moving the hydraulic pressure does not have to be maintained.

DE 195 16 639 A1 discloses a vehicle having an operating and parking brake system, wherein each brake system can be operated by means of an operating system associated with it, as well as having a triggering device working independently of these actuating systems, a device for producing braking pressure, and a friction brake, which work together such that, by actuating the triggering device, the pressure generator acts upon the friction brake and thereby an emergency braking can be initiated in the event of failure of the running brake system. It describes how the parking brake can be operated hydraulically and can be locked up mechanically.

The purpose of the invention is to further develop and to improve a hydraulic operating device of the kind described above.

This purpose is achieved in that the actuating system has an actuator, especially a control cylinder, which is mechanically coupled with the locking device and can be operated by hydraulic pressure in order to set the parking brake.

The actuator is mechanically joined to the parking brake by the locking device. With the actuator, which is preferably configured as a hydraulic cylinder, the braking force of the parking brake can be precisely adjusted and controlled. It is especially advantageous that the actuator can be operated with pressure from a pressure accumulator which is sometimes available in the vehicle. Thus, no additional pressure producer and pressure accumulator is necessary. In vehicles with an electrohydraulic running brake, the latter can be the stored-up braking pressure. In vehicles with a servohydraulic brake system, especially with an electronic stability program (ESP), it can be the brake pressure stored in a brake pressure accumulator for braking actions independent of the driver. Pressure can be fed through an output to the electrohydraulic running brake or to the pressure accumulator of the ESP, which can be controlled by an electromagnetic valve. The parking brake can be locked in the braking position by the locking device.

The actuating system, especially the intersection between the hydraulic and mechanical portions, can be arranged at any point in the vehicle. This is especially advantageous because the routing of the parking brake cable from an existing model can be used in a future model without any changes. The actuating system can accordingly be integrated into the vehicle with great flexibility.

In a preferred embodiment the actuating element is automatically resettable. This means that the actuating element moves automatically back to its starting position, so that after the parking brake is released it is immediately ready again for use.

In a further development the actuating element may have a resilient element, especially a spring element. This measure permits a structurally especially simple achievement of the automatically resettable actuating element. It is especially preferred that the actuating element be configured as a resettable actuating cylinder with a spring as the resetting element. In that case, when the parking brake is set, first the force of the spring in the actuating cylinder is overcome.

Advantageously, the locking system is a catch mechanism, an overrunning clutch or a wrap-around spring. The overrunning clutch can be of the roller-type. Especially preferred is a wrap-around spring which can be arranged on a cylinder arranged for rotation. A wrap-around spring is free of braking forces and thus easy to release.

An emergency release of the wrap-around spring can be realized in an especially simple manner with a cable control acting on the wrap-around spring.

An emergency release system is provided for releasing the lock-up of the parking brake. Especially for the case in which an ESP is provided in the vehicle, the locking device can be held in the released state by the release system. With the hydraulic application of the parking brake a dynamic can be realized such as is necessary for application while driving based on possible ESP/ABS interventions. Thus an auxiliary brake function can be achieved.

In an especially preferred improvement it can be arranged that the release system has a lifting magnet or a servo motor. Thus a reliable release of the locking device is assured. Both a lifting magnet and a servo motor can be controlled electrically.

In one embodiment of the invention the actuating system can be connected to a control of an electrohydraulic brake system digitally, especially through a CAN bus (Controller area network bus). This measure permits integrating the control of the actuating device into the control of the electrohydraulic operating brake. A sensor can be provided which monitors the actuating device, especially the setting or tightening and releasing the parking brake. The sensor signals can be communicated to the control through the CAN bus. Furthermore, it is conceivable to integrate the actuation of the lifting magnet or servo motor into the control of the electrohydraulic running brake and connect it to the running brake through the CAN bus.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic representation of one embodiment of the invention.

FIG. 2 is a schematic representation of another embodiment of the invention.

FIG. 3 is a schematic representation of a further embodiment of the invention.

### DETAILED DESCRIPTION OF THE DRAWINGS

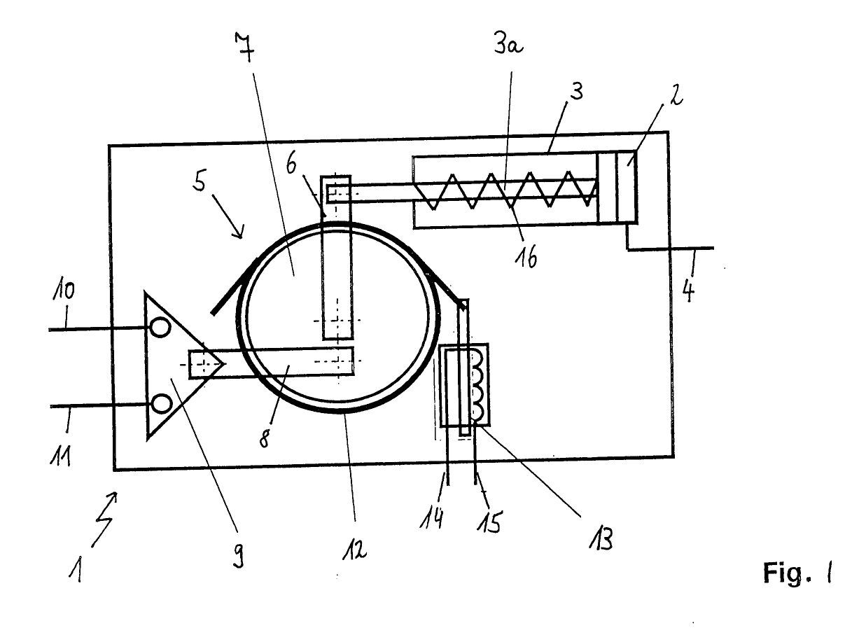

FIG. 1 shows a hydraulic actuating device 1. A chamber 2 of an actuating device 3 in the form of a hydraulic cylinder is connected by a hydraulic line 4 to an accumulator, not shown, the feeding of hydraulic fluid into chamber 2 being controlled by an electromagnetic valve which preferably is disposed at the outlet from the accumulator. The piston 3a of the actuating device 3 is connected with a parking brake by a setting mechanism which includes a locking device 5. If pressure is fed to the actuating device 3 the piston 3a moves leftward so that a connecting element 6, which is connected rotatably to the piston 3a and which in turn is rigidly fastened to the rotatably disposed cylinder 7 of the locking device 5, is deflected so that the cylinder 7 performs a counter-clockwise rotation. A second connecting element 8 is joined, for off-center rotation, to the cylinder 7 and is shifted to the right by the rotation of the cylinder 7. The pull cable receiver 9 connected to the connecting element 8 is also shifted rightward and thus pulls by the cable pulls 10 and 11 on a parking brake not shown. The pull cable receiver 9 is mounted rotatably to balance the pull cables. By the rotation of the cylinder 7 a wrap-around spring 12 of the locking device 5 is pulled and pressed against the periphery of cylinder 7, so that cylinder 7 is locked in its position. The parking brake thereby remains set, even if no more pressure is fed to the actuating device. A releasing device 13 in the form of a magnetic actuator is connected to the wrap-around spring 12 and is connected to a control via data conductors 14 and 15, especially via a CAN bus. If the releasing device 13 is activated, the wrap-around spring 12 is expanded and the locking of cylinder 7 is canceled so that the parking brake can release. Then the piston 3a is returned automatically to its starting position by an elastic element 16 in the form of a spring. Furthermore, the parking brake is thus reliably released.

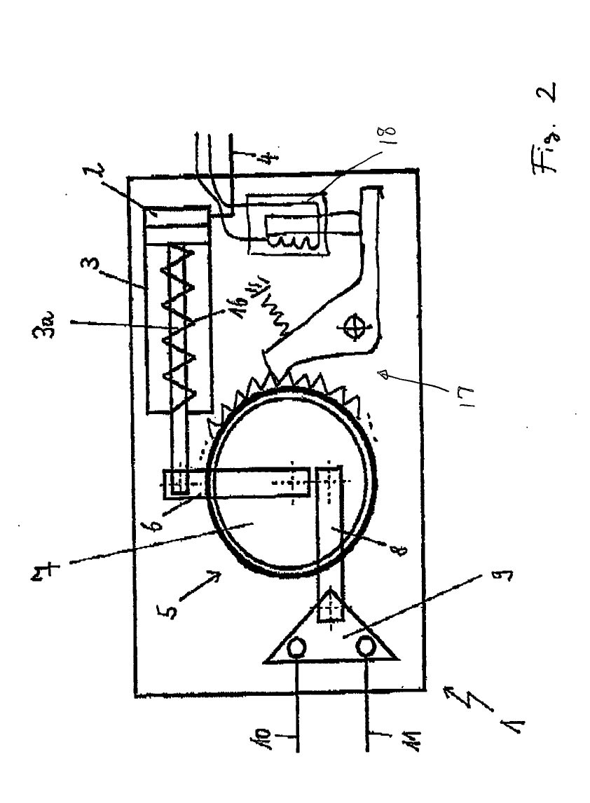

FIG. 2 shows another embodiment of the invention. In this embodiment, the wrap-around spring of the locking device shown in FIG. 1 is replaced with a catch mechanism 17. The catch mechanism 17 can be used to lock the cylinder 7 in its position to maintain the application of the brake when no pressure is fed to the actuating device 3. A releasing device 18, connected to a control, in the form of a magnetic actuator is used to release the catch mechanism 17.

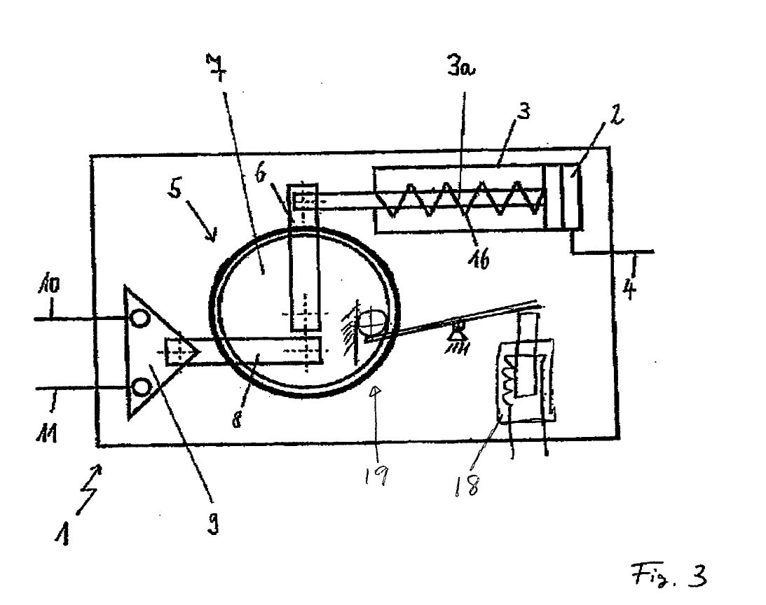

FIG. 3 shows a further embodiment of the invention. In this embodiment, the wrap-around spring of the locking device shown in FIG. 1 is replaced with an overrunning clutch 19. The overrunning clutch 19 can be used to lock the cylinder 7 in its position to maintain the application of the brake when no pressure is fed to the actuating device 3. A releasing device 18 in the form of a magnetic actuator is used to release the catch mechanism 17.

1. A hydraulic actuating system for a parking brake, comprising:
a locking device which is coupled with the parking brake and is configured to mechanically lock the parking brake; and
an actuating device, which is mechanically coupled with the locking device and is designed to receive hydraulic pressure in order to set the parking brake.

2. The system according to claim 1, wherein the actuating device is an operating cylinder.

3. The system according to claim 1, wherein the actuating device is automatically resettable.

4. The system according to claim 3, wherein the actuating device has a resilient element.

5. The system according to claim 3, wherein resilient element is a spring-elastic element.

6. The system according to claim 5, wherein the locking device comprises a catch mechanism, an overruning clutch or a wrap-around spring.

7. The system according to claim 6, wherein the wrap-around spring is connected to a pull cable for emergency release.

8. The system according to claim 7, further comprising a release system for releasing the locking device.

9. The system according to claim 1, further comprising a release system for releasing the locking device.

10. The system according to claim 9, wherein the release system includes a solenoid magnet or a servo-motor.

11. The system according to claim 1, wherein the actuating system is connected digitally with a control of an electrohydraulic brake system.

12. The system according to claim 11, wherein the actuating system is connected digitally with the control of the electrohydraulic brake system through a CAN-bus.

13. The system according to claim 1, wherein the locking device comprises a catch mechanism, an overruning clutch or a wrap-around spring.

14. The system according to claim 13, wherein the wrap-around spring is connected to a pull cable for emergency release.

15. The system according to claim 14, further comprising a release system for releasing the locking device.

16. The system according to claim 15, wherein the release system includes a solenoid magnet or a servo-motor.

17. The system according to claim 16, wherein the actuating system is connected digitally with a control of an electrohydraulic brake system.

18. A method for making a hydraulic actuating system for a parking brake, comprising the steps of:
coupling a locking device for mechanically locking the parking brake to the parking brake;
mechanically coupling an actuating device for receiving hydraulic pressure in order to set the parking brake to the locking device.
